(19) United States
(12) Patent Application Publication
(10) Pub. No.: US 2014/0224840 A1
(43) Pub. Date: Aug. 14, 2014

(54) MATERIAL GUIDE SUPPORT FOR SPREADER

(71) Applicant: Meyer Products, LLC, Cleveland, OH (US)

(72) Inventors: CHRISTOPHER ANDREW WILLIAMS NORKUS, CRESTON, IL (US); JAMES SCHAEFER, CHERRY VALLEY, IL (US)

(73) Assignee: Meyer Products, LLC, Cleveland, OH (US)

(21) Appl. No.: 14/175,486

(22) Filed: Feb. 7, 2014

Related U.S. Application Data
(60) Provisional application No. 61/762,614, filed on Feb. 8, 2013.

(51) Int. Cl. B65G 65/46

(52) U.S. Cl. CPC B65G 65/46
USPC 222/226

(57) ABSTRACT

A granular spreader assembly may include a hopper, a granular material moving mechanism, a material guide that is positioned within the hopper and a vibrator. One end of the material guide may extend toward the vibrator and may be separated from the inner surface of the hopper by an empty space.

### I. BACKGROUND OF THE INVENTION

A. Field of Invention

This invention pertains to the art of methods and devices used to spread granular material on ground surfaces, and more specifically to methods and apparatus regarding the support of a material guide within a spreader hopper.

B. Description of the Related Art

Granular spreader assemblies that spread granular material on ground surfaces are well known. One example is shown in FIGS. 1-4. The granular spreader assembly 10 may be mounted to a vehicle 12, such as a pick-up truck. In particular, the vehicle 12 may have a hopper receiving surface 15 onto which the granular spreader assembly 10 is positioned. Securing devices, such as belts 17, may be used to secure the granular spreader assembly 10 to the hopper receiving surface 15. The spreader assembly 10 may include a storage container (hopper) 14 that holds granular material, such as salt, and that has an opening 16 through which the granular material flows when exiting the hopper 14. The hopper 14 may have a back portion 19 that may face away from the vehicle 12 when the hopper 14 is mounted to the hopper receiving surface 15 and may have a front portion 21 that faces away from the back portion 19 when the hopper is mounted to the hopper receiving surface 15, as shown. The hopper 14 may have a front end wall 30 (toward the front of the vehicle), a back end wall 32 (toward the back of the vehicle) and a pair of side walls 44, 44. The spreader assembly 10 may also include an auger mechanism 18 that is rotated to move the granular material toward the opening 16 and a spinner mechanism 20 that is rotated to spread the material exiting the opening onto the surrounding ground surface.

With reference now to FIGS. 2-4, a material guide 22 may be positioned within the hopper 14 and used to guide the material toward the auger mechanism 18 in a desired manner. The material guide 22 is V shaped having a pair of angled sides 36, 38, though the V shape is inverted when installed, as shown. This invention will work with any material guide chosen with the sound judgment of a person of skill in the art. The material guide 22 is supported at a first end 24 to a plate 28, as seen best in FIG. 3, that is mounted to an inner surface of the back end wall 32 of the hopper 14 and is supported at a second end 26 to an inner surface of a the front end wall 30 of the hopper 14. The first end 24 is bolted to the plate 28 and the second end 26 is bolted to the front end wall 30. The material guide 22 becomes gradually smaller from front to back, as shown, to provide desired movement characteristics for the material.

With continuing reference to FIGS. 2-4, a vibrator mechanism 34 is used to vibrate the hopper 14 to assist with the movement of the material toward the bottom of the hopper 14. The vibrator mechanism 34 has a vibrator 40 attached to a bracket 42 that contacts an outer surface of the first sidewall 30. The bracket 42 is bolted to the plate 28, with the first sidewall 30 positioned between the bracket 42 and plate 28, and as a result the material guide 22 is vibrated by the vibrator 40

The granular spreader assembly 10 discussed above, and others like it, generally work well for their intended purposes. It may be desirable, however, to disconnect the vibrator from the material guide. One known way to accomplish this disconnection is to mount the vibrator on one of the side walls of the hopper. This design also generally works well for its intended purpose. Mounting the vibrator to a side wall, however, has the disadvantage of making it hard to access the vibrator once the granular spreader assembly is positioned within the vehicle. If the vibrator 40 was mounted to one of the side walls 44 of hopper 14, for example, the side panels 46 of the vehicle 12 would interfere with access to the vibrator 40, as shown in FIG. 1.

What is needed, then, is a granular spreader assembly that disconnects the material guide from the vibrator and provides easy access to the vibrator.

### II. SUMMARY

According to some embodiments of this invention, a granular spreader assembly may be used with an associated vehicle having a hopper receiving surface. The granular spreader assembly may comprise: (A) a hopper that: (1) comprises a holding compartment defined by a holding compartment surface that: (a) is suitable to hold associated granular material; and, (b) is defined by first and second opposed end walls and first and second opposed side walls; (2) has an opening through which the associated granular material flows when exiting the holding compartment; (3) comprises a back portion that: (a) faces away from the associated vehicle when the hopper is mounted to the hopper receiving surface; (b) comprises an inner surface of the first end wall defining a portion of the holding compartment surface; and, (c) comprises an outer surface that is external to the holding compartment; and, (4) comprises a front portion that faces away from the back portion when the hopper is mounted to the hopper receiving surface; (B) an auger mechanism that: (1) is positioned at least partially within the holding compartment; and, (2) is operable to move the associated granular material out of the holding compartment through the opening; (C) a material guide that: (1) is positioned within the holding compartment; (2) guides the associated granular material within the holding compartment toward the auger mechanism; (3) has a first end that extends toward inner surface of the first end wall; (4) has a second end that extends toward the front portion of the hopper; and, (5) is supported to the holding compartment surface with a first leg that operatively contacts the first side wall and a second leg that operatively contacts the second side wall; and, (D) a vibrator mechanism comprising a vibrator that: (1) is operable to vibrate the hopper to assist in causing the associated granular material within the holding compartment to move toward at least one of the auger mechanism and the opening; and, (2) is positioned external to the holding compartment and mountable to the outer surface of the back portion of the hopper. The first end of the material guide may be separated from the inner surface of the first end wall by an empty space that is at least 0.25 inches.

According to other embodiments of this invention, a granular spreader assembly may be used with an associated vehicle having a hopper receiving surface. The granular spreader assembly may comprise: (A) a hopper that: (1) comprises a holding compartment defined by a holding compartment surface that is suitable to hold associated granular material; (2) has an opening through which the associated granular material flows when exiting the holding compartment; (3) comprises a back portion that: (a) faces away from the associated vehicle when the hopper is mounted to the hopper receiving surface; (b) comprises an inner surface defining a portion of the holding compartment surface; and, (c) comprises an outer surface that is external to the holding compartment; and, (4) comprises a front portion that: (a) faces away from the back portion when the hopper is mounted to the hopper receiving surface; and, (b) comprises an inner surface defining a portion of the holding compartment surface; (B) a granular material moving mechanism that is operable to move the associated granular material out of the holding compartment through the opening; (C) a material guide that: (1) is positioned within the holding compartment; (2) guides the associated granular material within the holding compartment toward at least one of the granular material moving mechanism and the opening; (3) has a first end that extends toward the back portion of the hopper; (4) has a second end that extends toward the front portion of the hopper; and, (5) is supported to the hopper; and, (D) a vibrator mechanism comprising a vibrator that: (1) is operable to vibrate the hopper to assist in causing the associated granular material within the holding compartment to move toward at least one of the granular material moving mechanism and the opening; and, (2) is positioned external to the holding compartment on or near the outer surface of the back portion of the hopper. The first end of the material guide may be separated from the inner surface of the back portion by an empty space that is at least 0.25 inches. The second end of the material guide may be separated from the inner surface of the front portion by an empty space that is at least 0.25 inches.

According to yet other embodiments of this invention, a granular spreader assembly may be used with an associated vehicle having a hopper receiving surface. The granular spreader assembly may comprise: (A) a hopper that: (1) comprises a holding compartment defined by a holding compartment surface that is suitable to hold associated granular material; (2) has an opening through which the associated granular material flows when exiting the holding compartment; (3) comprises a back portion that: (a) faces away from the associated vehicle when the hopper is mounted to the hopper receiving surface; (b) comprises an inner surface defining a portion of the holding compartment surface; and, (c) comprises an outer surface that is external to the holding compartment; and, (4) comprises a front portion that faces away from the back portion when the hopper is mounted to the hopper receiving surface; (B) a granular material moving mechanism that is operable to move the associated granular material out of the holding compartment through the opening; (C) a material guide that: (1) is positioned within the holding compartment; (2) guides the associated granular material within the holding compartment toward at least one of the granular material moving mechanism and the opening; (3) has a first end that extends toward the back portion of the hopper; (4) has a second end that extends toward the front portion of the hopper; and, (5) is supported to the holding compartment surface with a first leg that is free floating with respect to the holding compartment surface; and, (D) a vibrator mechanism comprising a vibrator that: (1) is operable to vibrate the hopper to assist in causing the associated granular material within the holding compartment to move toward at least one of the granular material moving mechanism and the opening; (2) is positioned external to the holding compartment on the outer surface of the back portion of the hopper. The first end of the material guide may be separated from the inner surface of the back portion of the hopper by an empty space that is at least 0.25 inches.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a back perspective view of a pickup truck equipped with a known granular spreader assembly.

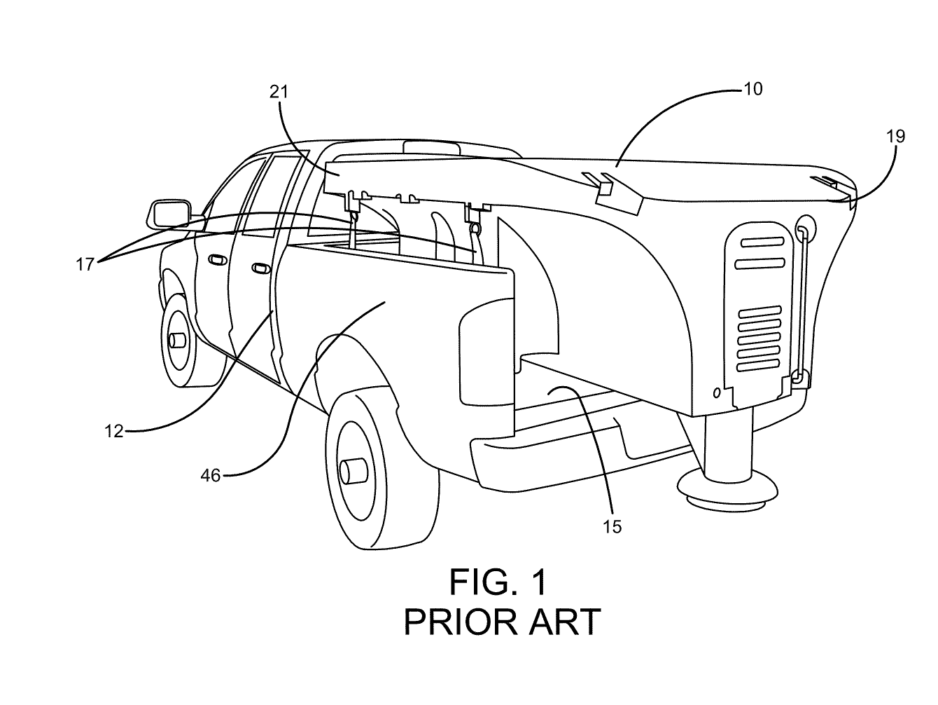

FIG. 2 is a side perspective view, partially cut away, of the granular spreader assembly shown in FIG. 1.

FIG. 3 is a top view of the material guide and vibrator mechanism, detached from the hopper, shown in FIG. 2.

FIG. 4 is perspective view of the vibrator mechanism, detached from the hopper, shown in FIGS. 2 and 3.

FIG. 5 is a side perspective view, partially cut away, of a granular spreader assembly according to some embodiments of this invention.

FIG. 6 is a top view of the granular spreader assembly shown in FIG. 5.

FIG. 7 is a sectional view along line 7-7 of FIG. 6.

FIG. 8 is a side perspective view, partially cut away, of a granular spreader assembly according to other embodiments of this invention.

FIG. 9 is a top view of the granular spreader assembly shown in FIG. 8.

FIG. 10 is a sectional view along line 10-10 of FIG. 9.

FIG. 11 is a perspective end view of a material guide according to another embodiment of this invention.

FIG. 12 is a top view of the material guide shown in FIG. 11.

### IV. DETAILED DESCRIPTION OF THE INVENTION

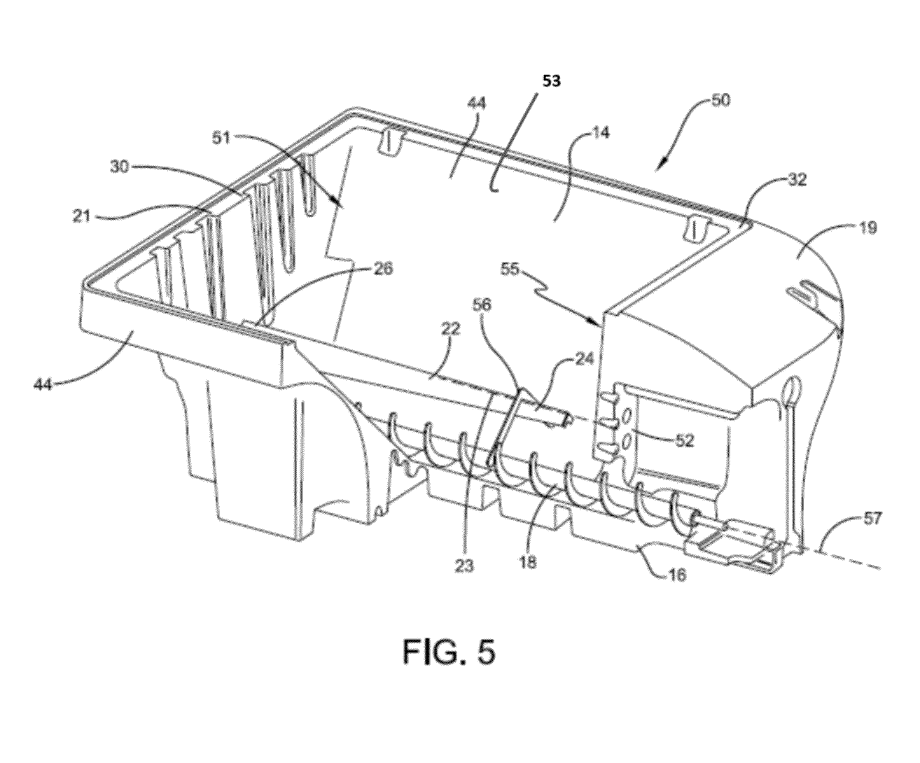

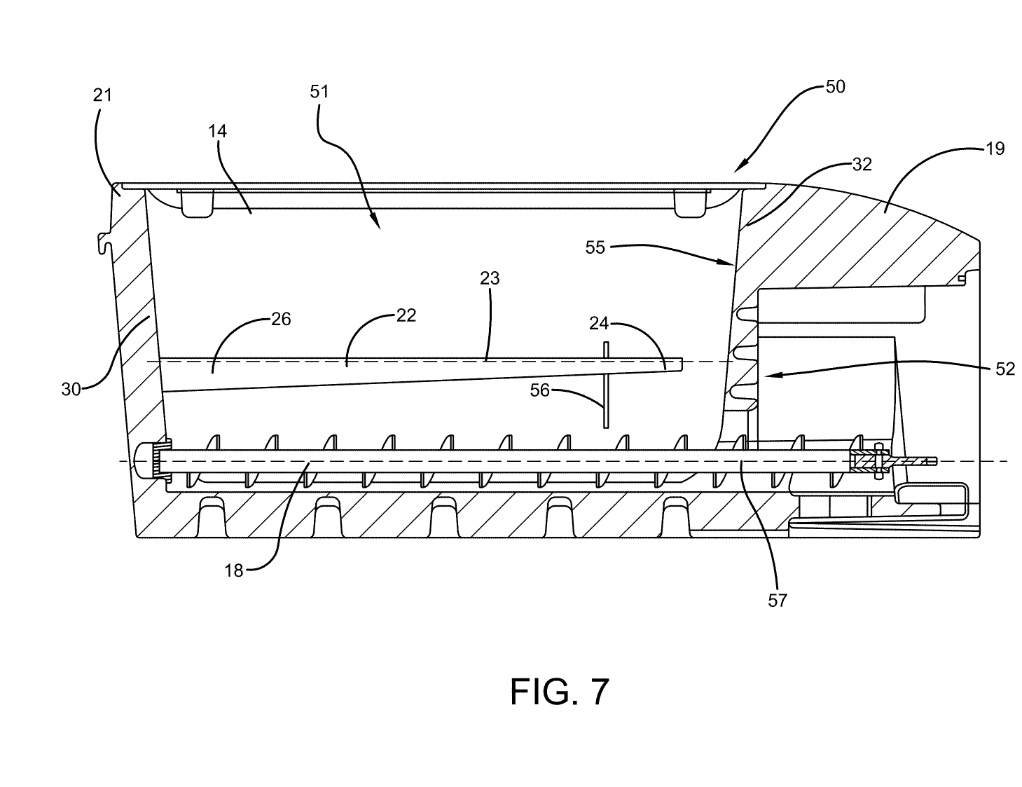

Referring now to the drawings wherein the showings are for purposes of illustrating embodiments of the invention only and not for purposes of limiting the same, and wherein like reference numerals are understood to refer to like components, FIGS. 5-7 show one set of embodiments of a granular spreader assembly 50 with a material guide supported as will be described below. Because many of the components used with the granular spreader assembly 50 may be similar to those described above regarding granular spreader assembly 10, the same reference numbers will be used. It should be noted, however, that any variation to the design chosen with the sound judgment of a person of skill in the art can be made. The granular spreader assembly 50 may be similarly supported to the vehicle's hopper receiving surface, as discussed above, or may be supported in any other manner chosen with the sound judgment of a person of skill in the art.

With reference now to FIGS. 5-10, The spreader assembly 50 may include a hopper 14 that may have a holding compartment 51 defined by a holding compartment surface 53 that is suitable to hold associated granular material such as, but not limited to, salt. The back portion 19 may include an inner surface 55 that is part of the holding compartment surface 53. The back portion 19 may also include an outer surface 52 that is external to the holding compartment 51. The holding compartment 51 may, in one specific embodiment, include a front end wall 30, an opposed back end wall 32, and a pair of opposed side walls 44, 44. Each of these walls 30, 32, 44, 44 may have an inner surface that defines the holding compartment surface 53, as shown. Other sizes and shapes of hopper holding compartments may be used with this invention.

With continuing reference to FIGS. 5-10, a granular material moving mechanism 18 may be operated to move granular material out of the holding compartment 51. The granular material moving mechanism 18 may, in the embodiment shown, move the granular material toward the opening 16 in the hopper 14. While the granular material moving mechanism 18 may be of any type chosen with the sound judgment of a person of skill in the art, such as a conveyor belt or chain belt, for the embodiment shown it is an auger mechanism 18. The auger mechanism 18 may have a longitudinal axis 57. While the auger mechanism 18 may be positioned in any location chosen with the sound judgment of a person of skill in the art, for the embodiment shown it is positioned with one end within the holding compartment 51 and the opposite end extending out of the holding compartment 51. A spinner mechanism, not shown but similar to a spinner mechanism 20 described above in one embodiment, may be operated to spread the material exiting the opening 16 onto the surrounding ground surface.

With reference now to FIGS. 5-12, a material guide 22 may be positioned within the hopper 14 and used to guide the material toward at least one of the granular material moving mechanism 18 and the opening 16 in a known manner. The material guide 22 may have any size and shape chosen with the sound judgment of a person of skill in the art. Specific embodiments will be described below. The material guide 22 may be positioned within the holding compartment 51, as shown. The material guide 22 may have a longitudinal axis 23. In one embodiment, shown, the longitudinal axis 23 of the material guide 22 may be parallel to the longitudinal axis 57 of the auger mechanism 18 although any relative position chosen with the sound judgment of a person of skill in the art may be used. In a more specific embodiment, shown, the longitudinal axes 23, 57 may be coplanar on a vertical plane that is perpendicular to a corresponding ground surface. The material guide 22 may have a first end 24 that extends toward the back portion 19 of the hopper 14 and a second end 26 that extends toward the front portion 21 of the hopper 14. In a specific embodiment, shown, the first end 24 extends toward the inner surface of hopper wall 32 while the second end 26 extends toward the inner surface of hopper wall 30. The material guide 22 may be supported to the hopper 14 in any manner chosen with the sound judgment of a person of skill in the art. Specific embodiments will be described below.

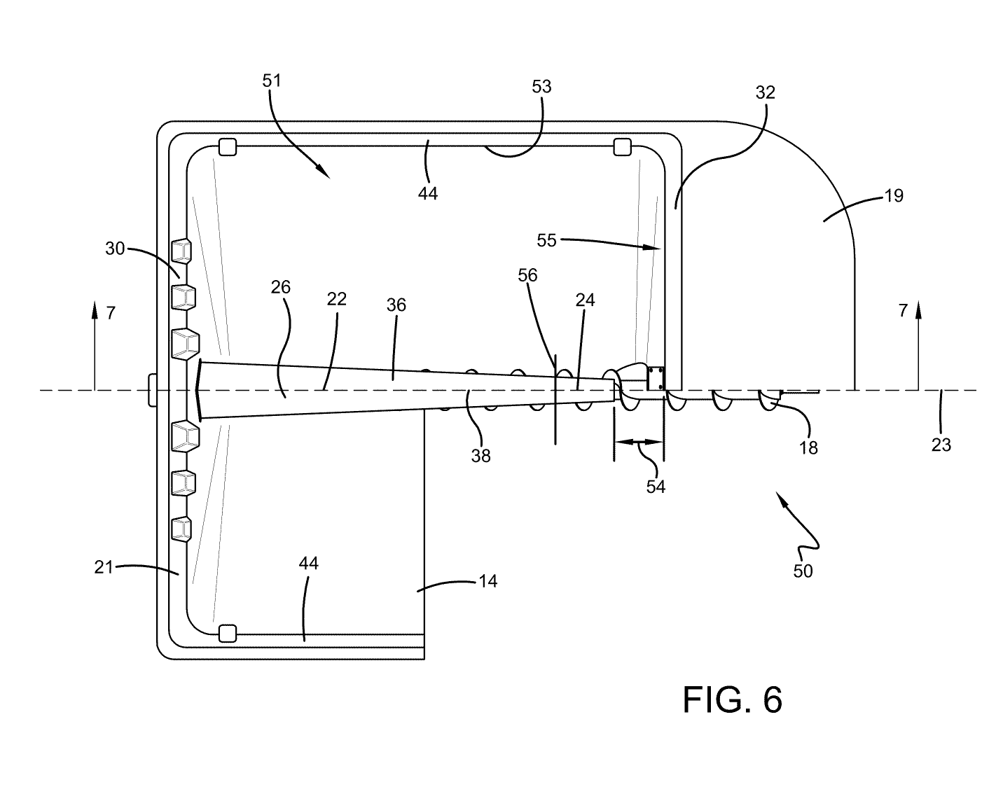

With reference now to FIGS. 5-7, one set of material guide embodiments will now be described. The material guide 22 may have an inverted V-shape, as shown. The second end 26 may have a larger width than the first end 24, as seen best in FIG. 6. The change in width may occur gradually, as shown. To support the material guide 22 to the hopper 14, the second end 26 of the material guide 22 may be fixedly attached to the front end wall 30. In a specific embodiment, the second end 26 may be fixedly attached via welding, connectors such as bolts, adhesives or the like. In another embodiment, the second end 26 may be fixedly attached to other hopper surfaces, such as to the side walls 44 with one or more legs 56 as will be discussed below. The first end 24 of the material guide 22 may not contact the inner surface 55 of the back portion 19 (which is also, in some embodiments, the inner surface of wall 32). The first end 24 may be separated from the inner surface by an empty space 54 (see FIG. 6). By empty space it is meant that no portion of the hopper 14 or related components are positioned within the space 54. It should be understood, however, that the granular material being spread may, depending on the fill status of the hopper, be temporarily positioned within the empty space 54. Empty space 54 can be any distance chosen with the sound judgment of a person of skill in the art. In one embodiment, empty space 54 is at least 0.25 inches; in another it is at least 0.5 inches; in another it is at least 0.75 inches; in another it is at least 1 inch; in another it is at least 1.5 inches; in another it is at least 2 inches; in another it is at least 3 inches; in another it is at least 4 inches; in another it is at least 5 inches; in another it is at least 6 inches. The empty space 54 may vary from hopper to hopper depending on the length of the material guide (which may vary from hopper to hopper).

With continuing reference to FIGS. 5-7, to support the first end 24 of the material guide 22 to the hopper 14, at least one leg 56, two shown as a pair of legs, may be used. Each leg 56 may have a first end that is operatively connected to the material guide 22 and a second end that is operatively connected to the holding compartment surface 53. In one embodiment, shown, the first ends of the pair of legs are also attached to each other, forming a V shape that matches the V shape of the material guide 22. The second ends of the legs 56 may be, in one embodiment, free floating with respect to the holding compartment surface 53. By free floating it is meant that while the second end of the leg 56 may contact the holding compartment surface 53, it is free to move relative to the surface 53. In one embodiment, the first ends are fixedly connected to the material guide 22 via welding, connectors or the like. In one embodiment, the second end of the leg 56 may slide relative to the holding compartment surface 53. The free floating arrangement provides for relative motion between the leg and the hopper. This relative motion minimizes damage that might otherwise occur if the material guide 22 receives forces not applied to the hopper 14. This could occur, for example, when salt or other granular material is moving within the hopper 14. In another embodiment, the second ends of the legs 56 may be fixedly attached to the holding compartment surface 53. This may be accomplished, for example, via welding, connectors such as bolts, adhesives or the like.

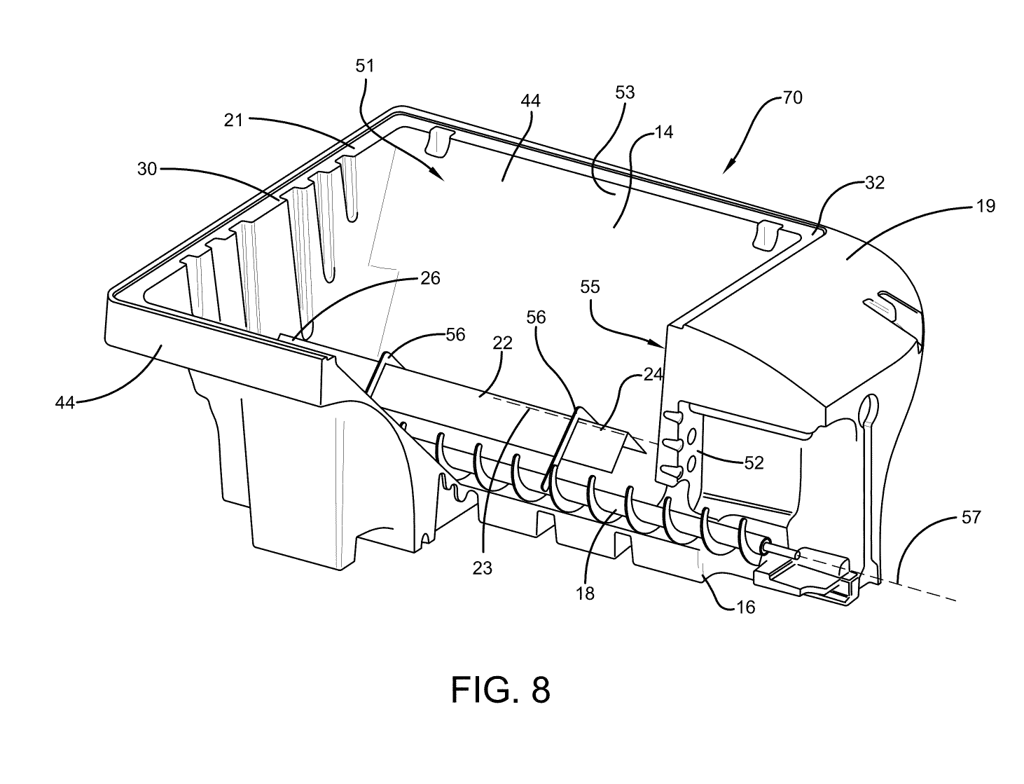

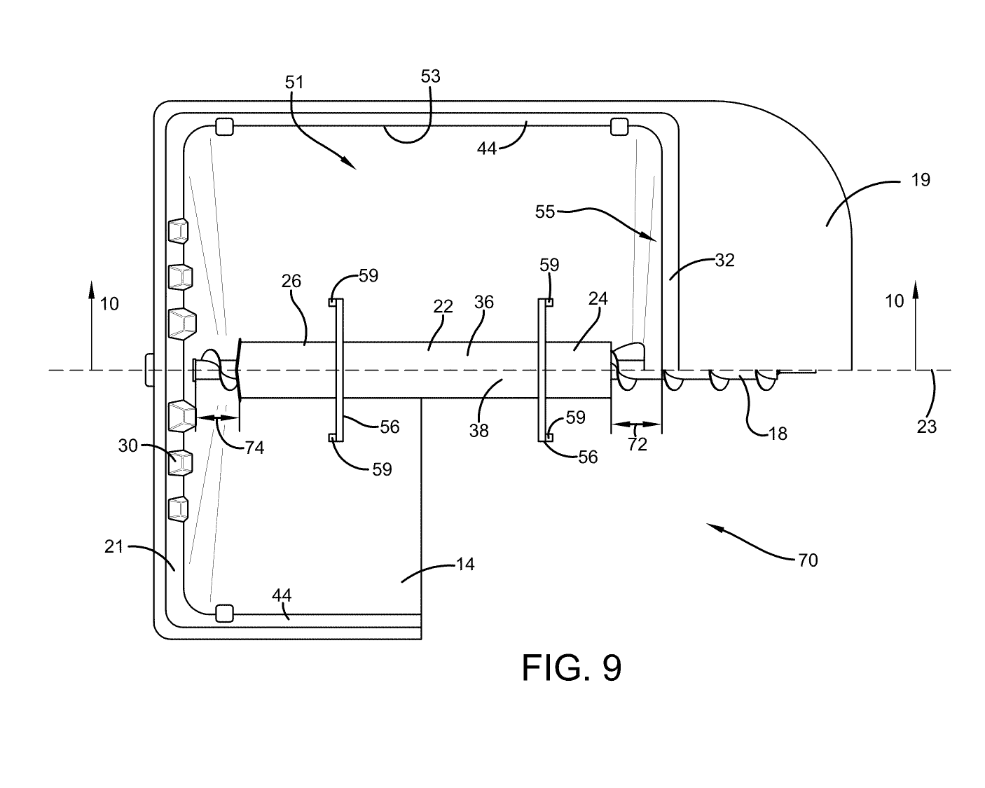

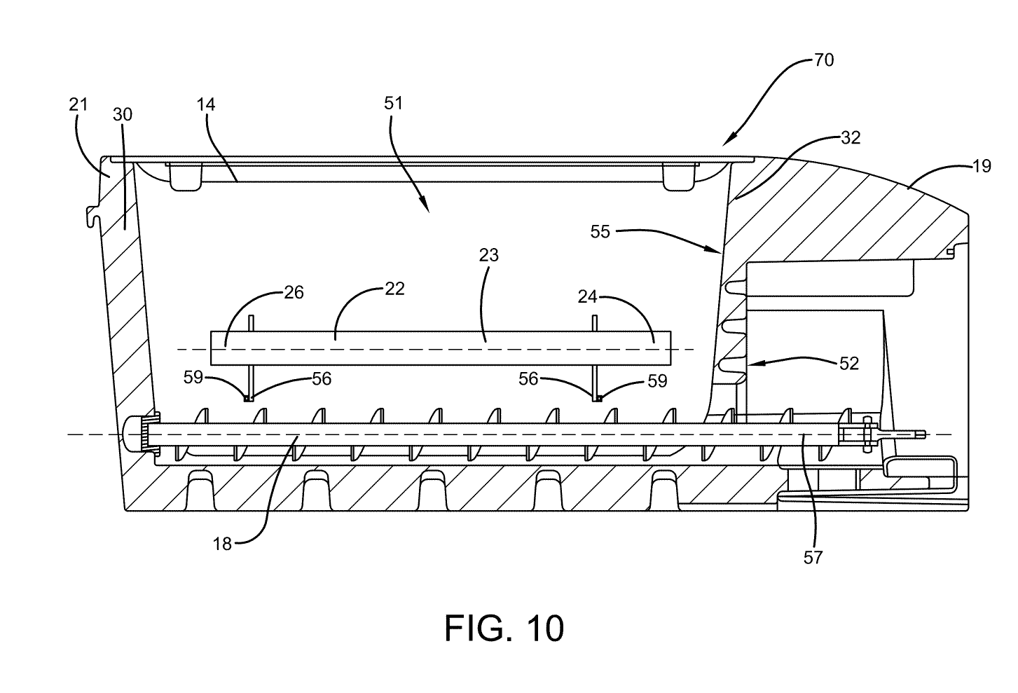

With reference now to FIGS. 8-10, another set of material guide embodiments will now be described as used with spreader assembly 70. The material guide 22 may have an inverted V-shape, as shown. The material guide 22 may have, in the embodiment shown, a constant width as seen best in FIG. 9. To support the material guide 22 to the hopper 14, both ends 24, 26 of the material guide 22 may be fixedly attached to the hopper side walls 14, 14. In one embodiment, at least one leg 56, two shown as a pair of legs, may be used at material guide end. Each leg 56 may have a first end that is operatively connected to the material guide 22 and a second end that is operatively connected to the holding compartment surface 53. In one embodiment, shown, the first ends of the pair of legs are also attached to each other, forming a V shape that matches the V shape of the material guide 22. The first ends may be fixedly attached to the material guide 22 via welding, connectors, adhesives or the like. The second ends of the legs 56 may be, fixedly attached to the side walls 14, 14 via welding, connectors such as bolts, adhesives or the like. The second ends may have flanges 59 which may have openings for this purpose (see FIGS. 9 and 10).

With continuing reference to FIGS. 8-10, the first end 24 of the material guide 22 may not contact the inner surface 55 of the back portion 19. The first end 24 may be separated from the inner surface by an empty space 72 (see FIG. 6). The second end 26, in one embodiment, may not contact the inner surface of the front portion 21. The second end 26 may be separated from the inner surface by an empty space 74. Empty spaces 72, 74 can be any distances chosen with the sound judgment of a person of skill in the art. In one embodiment, at least one of empty spaces 72, 74 is at least 0.25 inches; in another at least one is at least 0.5 inches; in another at least one is at least 0.75 inches; in another at least one is at least 1 inch; in another at least one is at least 1.5 inches; in another at least one is at least 2 inches; in another at least one is at least 3 inches; in another at least one is at least 4 inches; in another at least one is at least 5 inches; in another at least one is at least 6 inches. The spaces 72, 74 are the same in one embodiment but differ in another embodiment. The empty spaces 72, 74 may vary from hopper to hopper depending on the length of the material guide (which may vary from hopper to hopper).

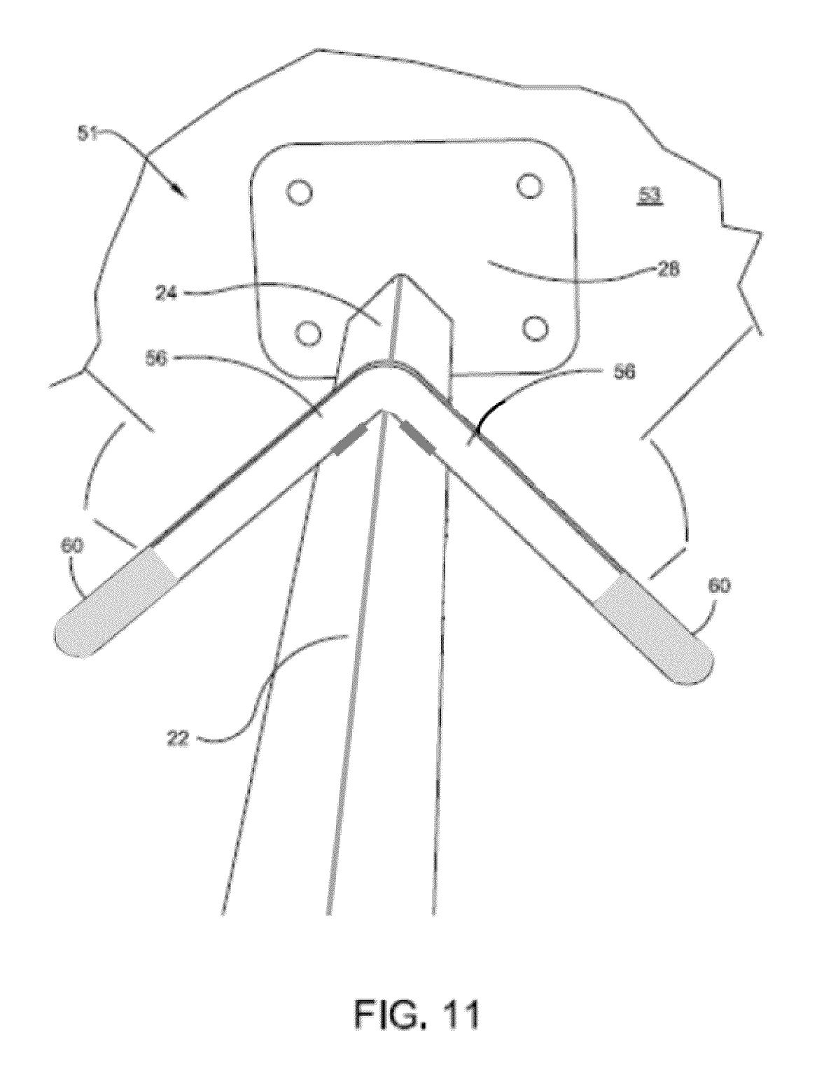

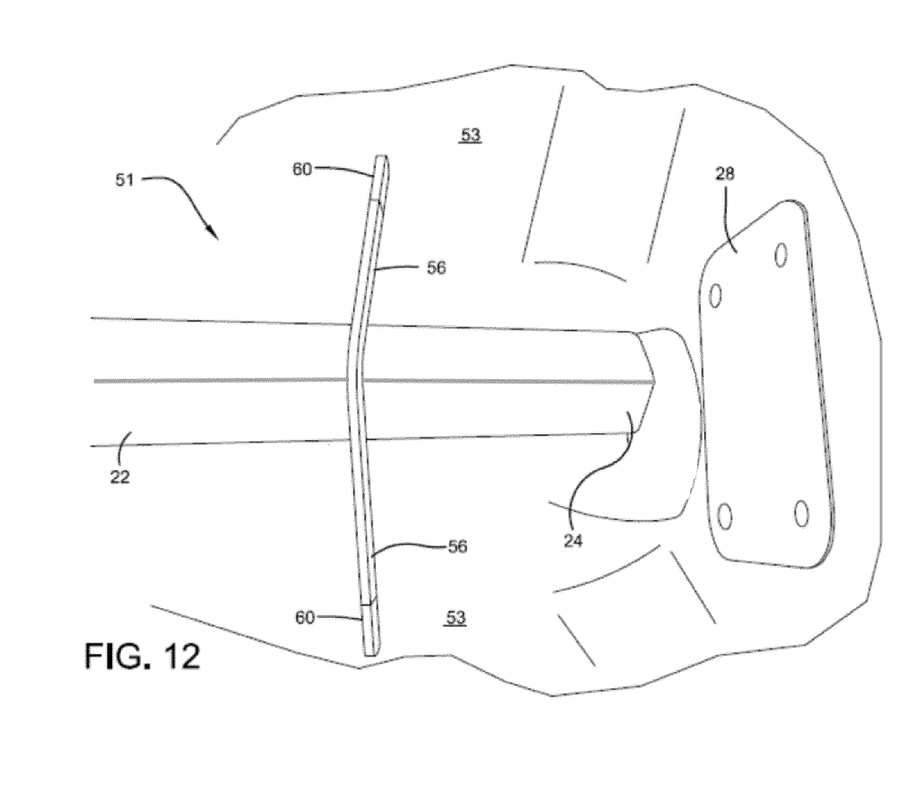

With reference now to FIGS. 11-12, other embodiments of legs 56 used with a material guide 22 will now be described. In these embodiments, a boot 60 is attached to the second ends of the legs 56, as shown. The boot 60 may be formed of a material that provides, in one embodiment, for free floating engagement with relatively minor friction so that relative motion is relatively easy to occur. In another embodiment, the boot 60 may be formed of a material that provides the free floating engagement with relatively major friction so that relative motion is relatively harder to occur, but still occurs should an adequate force be applied. The boot 60 may be attached to the leg 56 in any manner chosen with sound engineering judgment. In one embodiment, the boot 60 is held to the leg 56 with an adhesive. In another embodiment, it is extruded onto the leg 56. In yet another embodiment, the boot 60 is welded onto the leg 56. The boot 60 may be, in one embodiment, selectively removed from and attached to the leg 56 with ordinary human physical effort (no tools). In another embodiment, once attached, the boot 60 cannot be selectively removed with ordinary human effort. In one specific embodiment, the material guide 22 and legs 56 are made of Stainless Steel and the boot 60 is made of vinyl and is applied to a leg 56 in a dip coating procedure. A boot 60 may be used with any of the material guide embodiments discussed above.

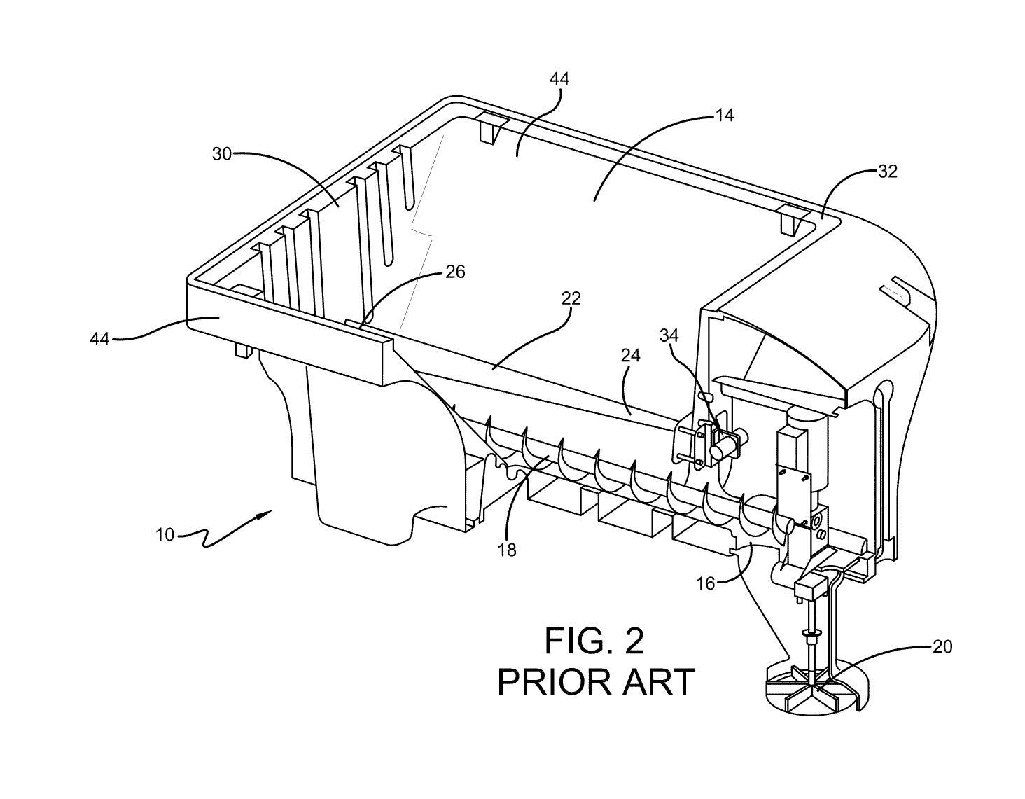

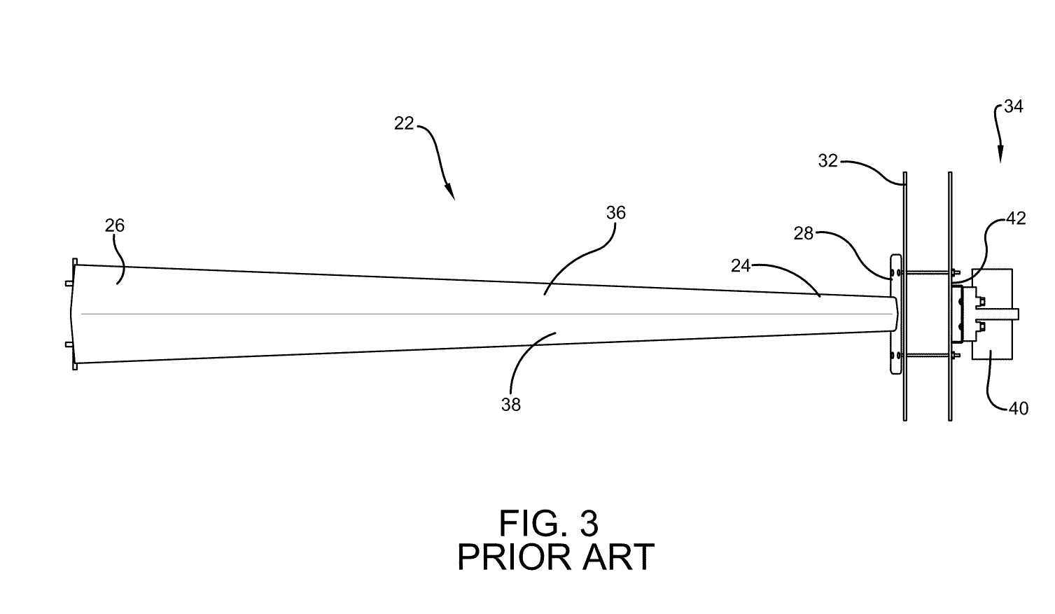

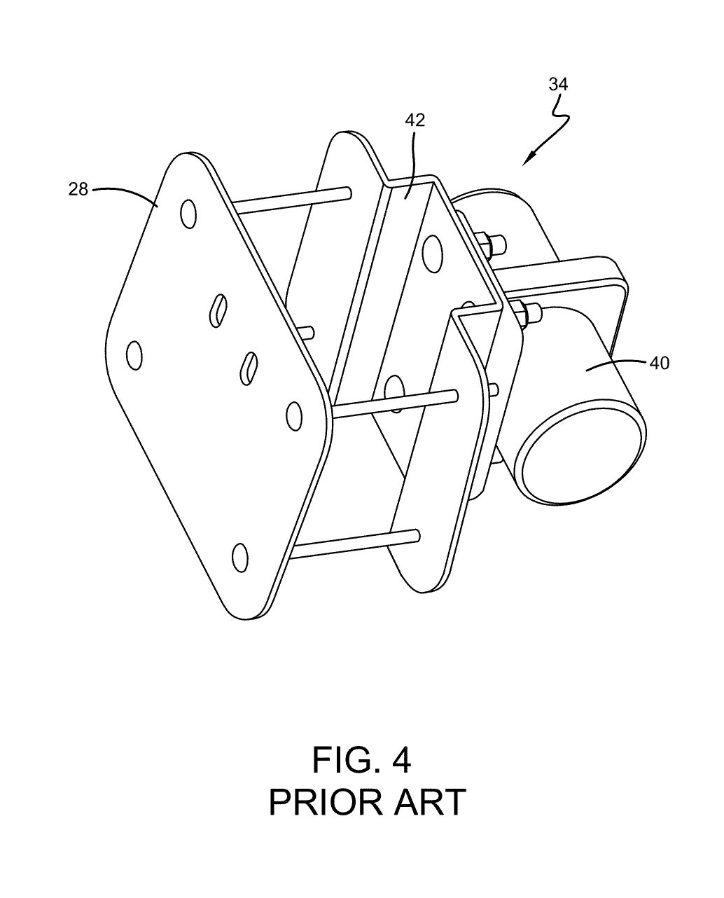

With reference now to FIGS. 2-10, a vibrator, such as vibrator 40 shown in FIGS. 2, 3 and 4, may be mounted to the outer surface 52 of the back end wall 32. This position makes for easy access to the vibrator for maintenance and replacement. It should be noted that with the empty spaces 54 (FIG. 6) and 72 (FIG. 9), operation of the vibrator will not directly vibrate the material guide 22 as is known in the prior art (see FIG. 2).

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A granular spreader assembly for use with an associated vehicle having a hopper receiving surface, the granular spreader assembly comprising:
a hopper that: (1) comprises a holding compartment defined by a holding compartment surface that: (a) is suitable to hold associated granular material; and, (b) is defined by first and second opposed end walls and first and second opposed side walls; (2) has an opening through which the associated granular material flows when exiting the holding compartment; (3) comprises a back portion that: (a) faces away from the associated vehicle when the hopper is mounted to the hopper receiving surface; (b) comprises an inner surface of the first end wall defining a portion of the holding compartment surface; and, (c) comprises an outer surface that is external to the holding compartment; and, (4) comprises a front portion that faces away from the back portion when the hopper is mounted to the hopper receiving surface;
an auger mechanism that: (1) is positioned at least partially within the holding compartment; and, (2) is operable to move the associated granular material out of the holding compartment through the opening;
a material guide that: (1) is positioned within the holding compartment; (2) guides the associated granular material within the holding compartment toward the auger mechanism; (3) has a first end that extends toward inner surface of the first end wall; (4) has a second end that extends toward the front portion of the hopper; and, (5) is supported to the holding compartment surface with a first leg that operatively contacts the first side wall and a second leg that operatively contacts the second side wall; and,
a vibrator mechanism comprising a vibrator that: (1) is operable to vibrate the hopper to assist in causing the associated granular material within the holding compartment to move toward at least one of the auger mechanism and the opening; and, (2) is positioned external to the holding compartment and mountable to the outer surface of the back portion of the hopper;
wherein the first end of the material guide is separated from the inner surface of the first end wall by an empty space that is at least 0.25 inches.

2. The granular spreader assembly of claim 1 wherein:
the first leg is free floating with respect to the first side wall; and,
the second leg is free floating with respect to the second side wall;

3. The granular spreader assembly of claim 2 wherein:
the first leg has a first end that is fixedly attached to the material guide and a second end;
a first boot is attached to the second end of the first leg and defines the free floating engagement of the first leg with respect to the first side wall;
the second leg has a first end that is fixedly attached to the material guide and a second end; and,
a second boot is attached to the second end of the second leg and defines the free floating engagement of the second leg with respect to the second side wall.

4. The granular spreader assembly of claim 2 wherein:
the second end of the material guide is fixedly attached to the second end wall.

5. The granular spreader assembly of claim 2 wherein:
the first end of the material guide is supported to the holding compartment with the first and second legs; and,
the second end of the material guide is supported to the holding compartment with a third leg that is fixedly attached to the first side wall and a fourth leg that is fixedly attached to the second side wall.

6. The granular spreader assembly of claim 2 wherein:
the first and second legs each have first and second ends;
the first end of the first leg is fixedly attached to the material guide and to the first end of the second leg;
the first end of the second leg is fixedly attached to the material guide;
the second end of the first leg defines the free floating engagement of the first leg with respect to the first side wall; and,
the second end of the second leg defines the free floating engagement of the second leg with respect to the second side wall.

7. The granular spreader assembly of claim 1 wherein:
the front portion comprises an inner surface of the second end wall defining a portion of the holding compartment surface; and,
the second end of the material guide is separated from the inner surface of the second end wall by an empty space that is at least 0.25 inches.

8. The granular spreader assembly of claim 7 wherein:
the first and second legs each have first and second ends;
the first ends of the first and second legs are fixedly attached to the first end of the material guide;
the second ends of the first and second legs are fixedly attached to the first and second side walls, respectively;
a third leg has a first end fixedly attached to the second end of the material guide and a second end fixedly attached to the first side wall; and,
a fourth leg has a first end fixedly attached to the second end of the material guide and a second end fixedly attached to the second side wall.

9. The granular spreader assembly of claim 1 wherein:
the first end of the material guide is separated from the inner surface of the first end wall by an empty space that is at least 0.5 inches.

10. A granular spreader assembly for use with an associated vehicle having a hopper receiving surface, the granular spreader assembly comprising:
a hopper that: (1) comprises a holding compartment defined by a holding compartment surface that is suitable to hold associated granular material; (2) has an opening through which the associated granular material flows when exiting the holding compartment; (3) comprises a back portion that: (a) faces away from the associated vehicle when the hopper is mounted to the hopper receiving surface; (b) comprises an inner surface defining a portion of the holding compartment surface; and, (c) comprises an outer surface that is external to the holding compartment; and, (4) comprises a front portion that: (a) faces away from the back portion when the hopper is mounted to the hopper receiving surface; and, (b) comprises an inner surface defining a portion of the holding compartment surface;
a granular material moving mechanism that is operable to move the associated granular material out of the holding compartment through the opening;
a material guide that: (1) is positioned within the holding compartment; (2) guides the associated granular material within the holding compartment toward at least one of the granular material moving mechanism and the opening; (3) has a first end that extends toward the back portion of the hopper; (4) has a second end that extends toward the front portion of the hopper; and, (5) is supported to the hopper;
a vibrator mechanism comprising a vibrator that: (1) is operable to vibrate the hopper to assist in causing the associated granular material within the holding compartment to move toward at least one of the granular material moving mechanism and the opening; and, (2) is positioned external to the holding compartment on or near the outer surface of the back portion of the hopper;
wherein the first end of the material guide is separated from the inner surface of the back portion by an empty space that is at least 0.25 inches; and,
wherein the second end of the material guide is separated from the inner surface of the front portion by an empty space that is at least 0.25 inches.

11. The granular spreader assembly of claim 10 wherein:
the holding compartment surface comprises a first side surface and a second side surface;
a first leg has a first end fixedly attached to the first end of the material guide and a second end that is fixedly attached to the first side surface; and,
a second leg has a first end fixedly attached to the second end of the material guide and a second end that is fixedly attached to the second side surface.

12. The granular spreader assembly of claim 11 wherein:
a third leg has a first end fixedly attached to the first end of the material guide and a second end that is fixedly attached to the first side surface;
the first end of the third leg is fixedly attached to the first end of the first leg;
a fourth leg has a first end fixedly attached to the second end of the material guide and a second end that is fixedly attached to the second side surface; and,
the first end of the fourth leg is fixedly attached to the first end of the second leg.

13. The granular spreader assembly of claim 12 wherein:
the first end of the material guide is separated from the inner surface of the back portion by an empty space that is at least 0.5 inches; and,
the second end of the material guide is separated from the inner surface of the front portion by an empty space that is at least 0.5 inches.

14. The granular spreader assembly of claim 13 wherein:
the granular material moving mechanism is an auger mechanism that has a longitudinal axis that is substantially parallel to a longitudinal axis of the material guide.

15. A granular spreader assembly for use with an associated vehicle having a hopper receiving surface, the granular spreader assembly comprising:
a hopper that: (1) comprises a holding compartment defined by a holding compartment surface that is suitable to hold associated granular material; (2) has an opening through which the associated granular material flows when exiting the holding compartment; (3) comprises a back portion that: (a) faces away from the associated vehicle when the hopper is mounted to the hopper receiving surface; (b) comprises an inner surface defining a portion of the holding compartment surface; and, (c) comprises an outer surface that is external to the holding compartment; and, (4) comprises a front portion that faces away from the back portion when the hopper is mounted to the hopper receiving surface; and,
a granular material moving mechanism that is operable to move the associated granular material out of the holding compartment through the opening;
a material guide that: (1) is positioned within the holding compartment; (2) guides the associated granular material within the holding compartment toward at least one of the granular material moving mechanism and the opening; (3) has a first end that extends toward the back portion of the hopper; (4) has a second end that extends toward the front portion of the hopper;
and, (5) is supported to the holding compartment surface with a first leg that is free floating with respect to the holding compartment surface;
a vibrator mechanism comprising a vibrator that: (1) is operable to vibrate the hopper to assist in causing the associated granular material within the holding compartment to move toward at least one of the granular material moving mechanism and the opening; and, (2) is positioned external to the holding compartment on the outer surface of the back portion of the hopper; and,
wherein the first end of the material guide is separated from the inner surface of the back portion of the hopper by an empty space that is at least 0.25 inches.

16. The granular spreader assembly of claim 15 wherein:
the holding compartment surface comprises a first side surface and a second side surface;
the first leg has a first end fixedly attached to the material guide and a second end that is free floating with respect to the first side surface; and,
a second leg has a first end fixedly attached to the material guide and a second end that is free floating with respect to the second side surface.

17. The granular spreader assembly of claim 16 wherein:
a first boot is attached to the second end of the first leg and defines the free floating engagement of the first leg with respect to the first side surface; and,
a second boot is attached to the second end of the second leg and defines the free floating engagement of the second leg with respect to the second side surface.

18. The granular spreader assembly of claim 17 wherein:
the second end of the material guide is fixedly attached to the holding compartment surface.

19. The granular spreader assembly of claim 17 wherein:
the first end of the first leg is fixedly attached to the first end of the material guide;
the first end of the second leg is fixedly attached to the first end of the material guide;
a third leg has a first end fixedly attached to the second end of the material guide and a second end that is free floating with respect to the first side surface; and,
a fourth leg has a first end fixedly attached to the second end of the material guide and a second end that is free floating with respect to the second side surface.

20. The granular spreader assembly of claim 17 wherein:
the granular material moving mechanism is an auger mechanism that has a longitudinal axis that is substantially parallel to a longitudinal axis of the material guide.
